(19) United States
(12) Patent Application Publication
(10) Pub. No.: US 2022/0237560 A1
(43) Pub. Date: Jul. 28, 2022

(54) DELIVERY PLAN CREATING SYSTEM, DELIVERY PLAN CREATING APPARATUS, AND DELIVERY PLAN CREATING METHOD

(71) Applicant: Hitachi, Ltd., Tokyo (JP)

(72) Inventors: Futoshi KOIKE, Tokyo (JP); Junko HOSODA, Tokyo (JP); Naoko KISHIKAWA, Tokyo (JP); Akane SETO, Tokyo (JP)

(21) Appl. No.: 17/575,841

(22) Filed: Jan. 14, 2022

(30) Foreign Application Priority Data
Jan. 26, 2021 (JP) 2021-010351

(51) Int. Cl. G06Q 10/08

(52) U.S. Cl. CPC G06Q 10/0838; G06Q 10/0832

(57) ABSTRACT

An object of the invention is to create a delivery plan in consideration of loadability for a package when the package has a new shape or a shape of the package changes during a delivery process. A delivery plan creating system includes: a stowage rule generation unit that generates stowage rules using delivery performance data including records of a type of a delivery vehicle and a type of a package to be delivered by the delivery vehicle and stores the stowage rules in a stowage rule storage unit; a delivery plan calculation unit that estimates a scheme of the package to be loaded on the delivery vehicle and creates a delivery plan using the scheme when the package to be loaded on each delivery vehicle in the scheme matches one of the stowage rules; and a display unit that displays the delivery plan.

### TECHNICAL FIELD

The present invention relates to a delivery plan creating system, a delivery plan creating apparatus, and a delivery plan creating method.

### BACKGROUND ART

Patent Literature 1 describes a technique in which “vehicle type (by type) data is generated by classifying vehicles (loaded objects) by shapes and sizes thereof, external shape features are represented by plural types of vectors for each vehicle representing a corresponding vehicle type, and external shape data is generated by approximating external shapes with envelopes of the vectors. The vehicle type data is then allocated to in-vehicle (loading) areas of a vehicle transporter (truck), and it is checked whether a vehicle of an allocated vehicle type and having its vehicle type data can be loaded in an area based on conditions of the area and external shape data of the vehicle.”

### CITATION LIST

### Patent Literature

PTL 1: JP-A-2001-202410

### SUMMARY OF INVENTION

### Technical Problem

In the technique described in Patent Literature 1, when a measurement location for each classification is set, it is possible to determine loadability of a delivery vehicle by measuring a shape of a package. However, it is not easy to determine loadability for a package when the package has a new shape or a shape of the package changes during a delivery process.

An object of the invention is to create a delivery plan in consideration of loadability for a package when the package has a new shape or a shape of the package changes during a delivery process.

### Solution to Problem

In order to solve the above problem, the present application employs, for example, a technique described in the claims. The invention includes plural techniques for solving the above problem, and an example thereof is a delivery plan creating system including: a stowage rule generation unit that generates stowage rules using delivery performance data including records of a type of a delivery vehicle and a type of a package to be delivered by the delivery vehicle and stores the stowage rules in a stowage rule storage unit; a delivery plan calculation unit that estimates a scheme of the package to be loaded on the delivery vehicle and creates a delivery plan using the scheme when the package to be loaded on the delivery vehicle in the scheme matches one of the stowage rules; and a display unit that displays the delivery plan.

### Advantageous Effect

According to the invention, it is possible to provide a technique of creating a delivery plan in consideration of loadability for a package when the package has a new shape or a shape of the package changes during a delivery process.

Problems, configurations, and effects other than those described above will become apparent from the following description of embodiments.

### BRIEF DESCRIPTION OF DRAWINGS

FIG. 1 shows a configuration example of a delivery plan creating system.

FIG. 2 shows an example of a data structure of delivery performance data.

FIG. 3 shows an example of a data structure of a package attribute storage unit.

FIG. 4 shows an example of a data structure of a delivery vehicle attribute storage unit.

FIG. 5 shows an example of a data structure of a stowage rule storage unit.

FIG. 6 shows an example of a hardware configuration of a delivery plan creating apparatus.

FIG. 7 shows an example of a flowchart of a delivery plan creating process.

FIG. 8 shows an example of a flowchart of a stowage rule creating process.

FIG. 9 shows an output example of a delivery plan.

FIG. 10 shows an example of a flowchart of a stowage rule manual generation process.

FIG. 11 shows an example of a display screen of a stowage operation.

FIG. 12 shows a configuration example of another delivery plan creating system.

FIG. 13 shows an example of a data structure of a similar attribute definition.

FIG. 14 shows an example of a determination criterion for a similar attribute.

FIG. 15 shows an example of a flowchart of a similar attribute definition addition process.

FIG. 16 shows apart of an example of a flowchart of a delivery plan creating process.

FIG. 17 shows an output example of a delivery plan.

### DESCRIPTION OF EMBODIMENTS

In the following embodiments, description may be divided into plural sections or embodiments if necessary for convenience. Unless particularly specified, the sections or embodiments are not independent of each other, but have a relation in which one section or embodiment is a modification, detailed description, supplementary description, or the like of a part or all of another section or embodiment.

In the following embodiments, when reference is made to the number of elements and the like (including a count, a numeric value, a quantity, a range, and the like), unless otherwise specified or theoretically apparently limited to a specific number, the number is not limited to a specific number and may be either equal to or larger than or equal to or less than the specific number.

In the following embodiments, it is needless to say that elements (including steps and the like) are not necessarily essential unless otherwise particularly specified or clearly considered to be essential in principle.

Similarly, in the following embodiments, when reference is made to shapes, positional relations, and the like of the elements or the like, the elements or the like include those having substantially approximate or similar shapes or the like unless otherwise particularly specified or clearly considered to be not the case in principle. The same applies to numerical values and ranges.

In all the drawings showing the embodiments, the same members are denoted by the same reference numerals in principle, and repetitive descriptions thereof will be omitted. However, when it is highly probable to cause confusion if a name is shared by members before and after a change due to an environmental change or the like, another different reference numeral or name may be given to even the same member. Hereinafter, the embodiments of the invention will be described with reference to the drawings.

Generally, in order to load a package in a cargo compartment of a delivery vehicle, it is necessary to dispose the package such that a shape of the package fits the cargo compartment, in addition to a total weight of the package being within a loading weight range of the delivery vehicle. Since small packages are often stored in rectangular parallelepiped packaging materials or the like, it is possible to relatively easily load the packages by stacking the packages according to a shape of the cargo compartment. On the other hand, it is difficult to pack a large package having a complicated shape as a whole, and thus it is necessary to load the package in consideration of a structure of the cargo compartment while protecting a part of the package. Further, it is necessary to consider interference between packages depending on shapes of the packages and loading positions, and it is probably difficult to load plural packages having different shapes.

In addition, a package may go through plural factories during a delivery process and be processed in each factory. In such a case, the shape of the package may change each time due to a change in the shape of the package itself after addition of a function or the like, or due to addition of a delivery member after addition of a precision component, and it may be difficult to manage package shape data for stowage.

In the following embodiments, various factors as a result of an effect of a package, a delivery method, or the like on delivery are expressed as “attributes”. The factors (hereinafter, referred to as package attributes) related to the package or the delivery method include both a factor indicating a physical feature of the package, such as a shape or a weight of the package, and a factor related to a package in a delivery service, such as a type of processing performed in the delivery process, a type of a delivery vehicle in which the package is loaded, and a loading position in the delivery vehicle.

In the following description, an “input unit,” a “display unit,” and an “interface device” may be one or more interface devices. The one or more interface devices may be at least one of the following devices.

One or more Input/Output (I/O) interface devices. The I/O interface device is an interface device for at least one of an I/O device and a remote display computer. The I/O interface device for a display computer may be a communication interface device. At least one I/O device may be a user interface device, for example, either of an input device such as a keyboard and a pointing device, and an output device such as a display device.

One or more communication interface devices. The one or more communication interface devices may be one or more communication interface devices of the same type (for example, may be one or more network interface cards (NICs)), or two or more communication interface devices of different types (for example, an NIC and a host bus adapter (HBA)).

In the following description, a “memory” may be one or more memory devices that are an example of one or more storage devices, and may be typically a main storage device. At least one memory device in the memory may be a volatile memory device or a non-volatile memory device.

In the following description, a “persistent storage device” may be one or more persistent storage devices that are an example of one or more storage devices. Typically, the persistent storage device maybe a non-volatile storage device (for example, an auxiliary storage device), and specifically, may be a hard disk drive (HDD), a solid state drive (SSD), a non-volatile memory express (NVME) drive, or a storage class memory (SCM).

In the following description, a “storage unit” or a “storage device” may be a memory or both of a memory and a persistent storage device.

In the following description, a “processing unit” or a “processor” may be one or more processor devices. Typically, at least one processor device may be a microprocessor device such as a central processing unit (CPU), and may be another type of processor device such as a graphics processing unit (GPU). The at least one processor device may be a single core or a multi-core. The at least one processor device may be a processor core. The at least one processor device may be a processor device in abroad sense such as a circuit (for example, a field-programmable gate array (FPGA), a complex programmable logic device (CPLD), and an application specific integrated circuit (ASIC)) that executes a part of or all of processing and is an aggregation of gate arrays by a hardware description language.

In the following description, an expression of “xxx unit” may be used to describe a function. The function may be implemented by a processor executing one or more computer programs, or may be implemented by one or more hardware circuits (for example, a FPGA or an ASIC), or may be implemented by a combination of the above implementation methods. When the function is implemented by a processor executing a program, the function may be at least a part of the processor since predetermined processing is executed by appropriately using a storage device and/or an interface device. The processing described using the function as a subject may be processing performed by a processor or by a device including the processor. The program may be installed from a program source. The program source may be, for example, a program distribution computer or a recording medium (for example, a non-transitory recording medium) readable by a computer. Description for each function is an example, and plural functions may be combined into one function, or one function may be divided into plural functions.

In the following description, processing may be described using a “program” or a “processing unit” as a subject . Alternatively, processing described using a program as a subject may be processing performed by a processor or by a device including the processor. Two or more programs may be implemented as one program, or one program may be implemented as two or more programs.

In the following description, an expression such as “xxx table” may be used to describe information that is acquired as an output in response to an input. Alternatively, the information may be a table of any structure, or may be a learning model such as a neural network that generates an output in response to an input, a genetic algorithm, and a random forest. Therefore, the “xxx table” can be referred to as “xxx information”. In the following description, a configuration of each table is an example, one table may be divided into two or more tables, and all or a part of two or more tables may be one table.

In the following description, a “delivery plan creating system” may be a system including one or more physical computers or a system (for example, a cloud computing system) implemented on a physical calculation resource group (for example, a cloud infrastructure). “Displaying” display information by the delivery plan creating system may refer to displaying the display information on a display device included in a computer, or may refer to transmitting the display information from the computer to a display computer (in the latter case, the display information is displayed by the display computer).

[First Embodiment] In the present embodiment, an example will be described in which plural schemes of combinations of delivery vehicles and package stowage are obtained and a scheme matching stowage having actual performance is adopted as a delivery plan.

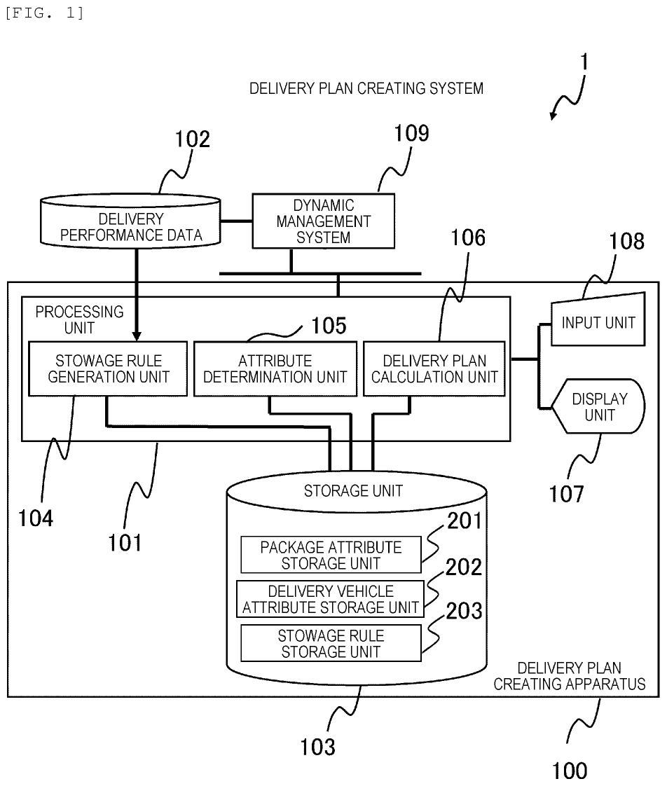

FIG. 1 shows a configuration example of a delivery plan creating system. A delivery plan creating system 1 includes a delivery plan creating apparatus 100 and an external dynamic management system 109 communicably connected to the delivery plan creating apparatus 100. The dynamic management system 109 stores information on stowage having delivery performance as delivery performance data 102. The dynamic management system 109 monitors and collects a delivery state of a delivery vehicle by an in-vehicle device mounted on the delivery vehicle, and creates the delivery performance data 102. A configuration of the dynamic management system 109 and contents of software processing are constructed by existing techniques.

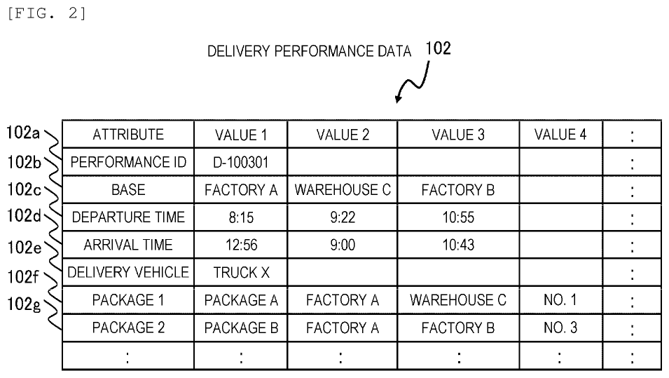

FIG. 2 shows an example of a data structure of delivery performance data. The delivery performance data 102 is record information on delivery for each delivery vehicle. The delivery performance data 102 may be implemented in a table format. In the delivery performance data 102, a vertical axis stores attributes of the delivery performance, and a horizontal axis correspondingly stores one or plural values of each attribute. The attributes of the delivery performance on the vertical axis can be added or changed by a user according to a delivery form, and an attribute value on the horizontal axis can be plural different values such as a value 1, a value 2, and a value 3 when there are plural attribute values. If necessary, it is also possible to combine attribute values with plural meanings into one attribute by combining the attribute values with a symbol such as “_” (underscore).

For example, the attribute of the delivery performance of the delivery performance data 102 includes, for each performance ID 102a assigned to identify an individual delivery performance, a base 102b indicating a starting point and a destination, departure time 102c and arrival time 102d for each base, a delivery vehicle 102e used for delivery, and packages 102f and 102g to be delivered. Each of the packages 102f and 102g has a package name for identifying the package, a starting point, a destination, and a loading position at the time of delivery as values 1 to 4, respectively. Each of the attribute values of the delivery performance data 102 is collected and recorded through the in-vehicle device or the like of the delivery vehicle (truck) at the time of loading and unloading a package.

Return to FIG. 1. The delivery plan creating apparatus 100 includes a processing unit 101, a storage unit 103, a display unit 107, and an input unit 108. The storage unit 103 includes a package attribute storage unit 201, a delivery vehicle attribute storage unit 202, and a stowage rule storage unit 203.

The delivery plan creating apparatus 100 is connected to the dynamic management system 109 via a communication network (for example, a local area network (LAN), a wide area network (WAN), or Internet). The communication network may be, for example, any one of a virtual private network (VPN), a communication network using apart or all of a general public line such as the Internet, a mobile phone communication network, or a combined network thereof. The communication network may be a wireless communication network such as Wi-Fi (registered trademark) or 5G (Generation).

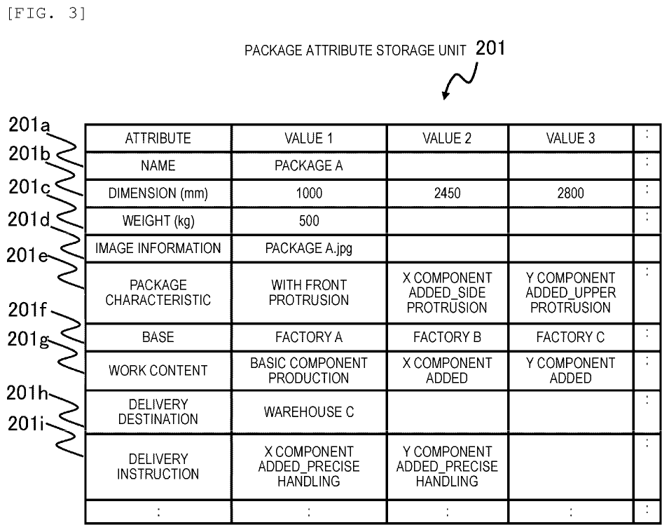

FIG. 3 shows an example of a data structure of a package attribute storage unit. The data structure of the package attribute storage unit 201 can be expressed in one table format for one package. In the package attribute storage unit 201, a vertical axis stores attributes of the package, and a horizontal axis correspondingly stores one or plural values of each attribute.

The attributes of the package on the vertical axis can be added or changed by the user according to the package, and an attribute value on the horizontal axis can be plural different values such as a value 1, a value 2, and a value 3 when there are plural attribute values. If necessary, it is also possible to combine attribute values with plural meanings into one attribute by combining the attribute values with a symbol such as “_” (underscore).

The attributes of the package in the package attribute storage unit 201 include, for example, a name 201a indicating a name of the package, a dimension 201b indicating a rough dimension of the package, a weight 201c indicating a weight of the package, image information 201d indicating image information obtained by imitating and graphing a shape of the package, a package characteristic 201e indicating a characteristic of a shape of the package, a base 201f that is a stopover point in a process of processing the package, a work content 201g indicating a work content at each base, a delivery destination 201h indicating a delivery destination of the package, and a delivery instruction 201i indicating an instruction to be handled at the time of delivery of the package.

Here, it is assumed that the dimension 201b has attribute values obtained by measuring maximum values of a width, a height, and a depth of the package. The package may have protrusions or different shapes on left and right sides, which complicates a measurement method when showing an exact size. However, in the description, a bounding box is treated only as an attribute value, and an attribute value to be described later is comprehensively interpreted to determine a loading method of the package. A specific shape of the package can be visually expressed as image information in the image information 201d. An attribute value of the image information 201d may be link information to an external image file.

The package characteristic 201e represents a characteristic shape of the package. It is assumed that an expression format as an attribute value of the package characteristic 201e is selected alternatively from values in which attribute values indicating characteristics are finitely listed in advance for all target packages. For example, the attribute value of the package characteristic 201e may include values such as “with front protrusion” and “side protrusion.” Considering that a package is processed during the delivery process and a shape thereof changes, the work content of performing the processing is also set as an attribute value. For example, two attributes of the work content and a shape change due to the work are connected by an underscore “_” and expressed as “X component added_side protrusion” or the like.

The work content 201g indicates a content of work on the package, and matches the work content set in the package characteristic 201e. A base at which the work content is performed is associated with a setting position of the attribute value of the base 201f. The delivery instruction 201i is to set a package delivery method, such as performing special packaging for precision equipment delivery. The delivery instruction 201i may include an attribute indicating a delivery method in advance. In consideration of an change in the delivery method due to processing, for example, two attributes of the work content and the change in the delivery method due to the work are connected by an underscore “_” and expressed as “X component added_precise handling” or the like. Since the package attribute storage unit 201 serves as input information for creating a delivery plan, the package attribute storage unit 201 needs to be defined before creating the delivery plan.

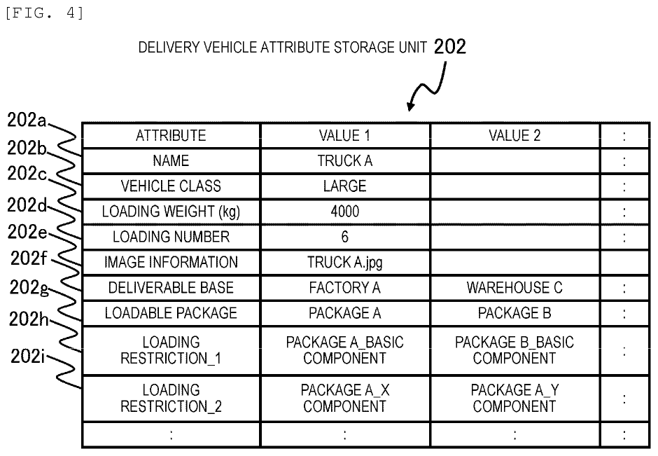

FIG. 4 shows an example of a data structure of a delivery vehicle attribute storage unit. The data structure of the delivery vehicle attribute storage unit 202 can be expressed in one table format for one delivery vehicle. In the delivery vehicle attribute storage unit 202, a vertical axis stores attributes of the delivery vehicle, and a horizontal axis correspondingly stores one or plural values of each attribute.

The attributes of the delivery vehicle on the vertical axis can be added or changed by the user according to a delivery vehicle, and an attribute value on the horizontal axis can be plural different values such as a value 1, a value 2, and a value 3 when there are plural attribute values. If necessary, it is also possible to combine attribute values with plural meanings into one attribute by combining the attribute values with a symbol such as “_” (underscore).

The attributes of the delivery vehicle in the delivery vehicle attribute storage unit 202 include, for example, a name 202a indicating a name of the delivery vehicle, a vehicle class 202b indicating a vehicle class of the delivery vehicle, a loading weight 202c indicating a loading weight of the delivery vehicle, a loading number 202d indicating the number of packages that can be loaded by the delivery vehicle, image information 202e indicating image information obtained by imitating and graphing a shape of a cargo compartment, a deliverable base 202f indicating a base where the delivery vehicle can stop in consideration of the size of the delivery vehicle, a loadable package 202g indicating a package that can be loaded by the delivery vehicle, and a loading restriction_1 (202h) and a loading restriction_2 (202i) that express restrictions on loaded packages for each loading position of the delivery vehicle.

A specific shape of the cargo compartment can be visually expressed as image information in the image information 202e. The image information 202e may be link information to an external file. The loading restriction_1 (202h) and the loading restriction_2 (202i) are, when there is a loading position where a specific cargo cannot be loaded due to the shape of the cargo compartment of the delivery vehicle, associated with packages that can be loaded at the loading position (the loading restriction_1 is a position identified as “1” in the cargo compartment, and loading restriction_2 is a position identified as “2” in the cargo compartment) as attribute values. Each attribute value of the loading restriction is defined in advance based on the package and a cargo compartment structure of the delivery vehicle. Since the delivery vehicle attribute storage unit 202 serves as input information for creating a delivery plan, the delivery vehicle attribute storage unit 202 needs to be defined before creating the delivery plan.

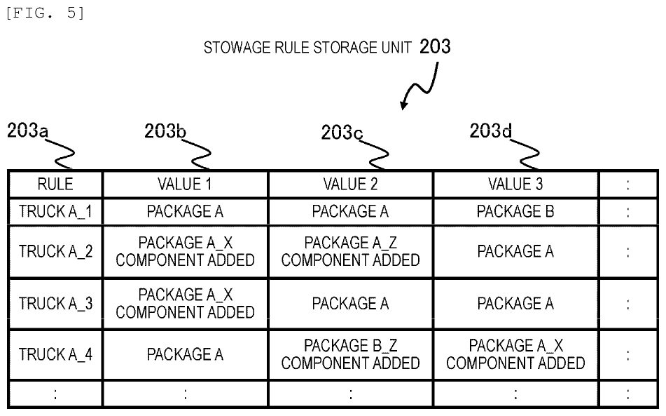

FIG. 5 shows an example of a data structure of a stowage rule storage unit. The stowage rule storage unit 203 uses, as a rule, a practical pattern among variations of stowage patterns of packages in each delivery vehicle. In the stowage rule storage unit 203, a rule 203a indicating a name of the rule is stored in association with a value 1 (203b), a value 2 (203c), and a value 3 (203d) for each rule. The rule 203a is a name expressed by connecting a delivery vehicle name (truck A) and numbers (1, 2, 3, and so on) assigned to the individual delivery vehicle with “_” (underscore). The value 1 (203b) stores an attribute value for specifying a package loaded at a head of the loading position of the cargo compartment, the value 2 (203c) stores an attribute value for specifying a package loaded second from the head of the loading position of the cargo compartment, and the value 3 (203d) stores an attribute value for specifying a package loaded third from the head of the loading position of the cargo compartment.

Return to FIG. 1. The processing unit 101 includes a stowage rule generation unit 104, an attribute determination unit 105, and a delivery plan calculation unit 106.

The stowage rule generation unit 104 receives the delivery performance data 102, the package attribute storage unit 201, and the delivery vehicle attribute storage unit 202 as inputs, and creates the stowage rule storage unit 203. That is, the stowage rule generation unit 104 generates a stowage rule using the delivery performance data 102 including records of a type of the delivery vehicle and a type of the package delivered by the delivery vehicle, and stores the stowage rule in the stowage rule storage unit 203.

The attribute determination unit 105 is a processing unit corresponding to a parser that handles data stored in the package attribute storage unit 201, the delivery vehicle attribute storage unit 202, and the stowage rule storage unit 203 as object data in accordance with structures thereof.

The delivery plan calculation unit 106 estimates a scheme of a package to be loaded on the delivery vehicle, and creates a delivery plan using the scheme when a package to be loaded on each delivery vehicle in the scheme matches at least one of stowage rule.

The display unit 107 creates information for displaying a processing result such as the delivery plan to the user.

The input unit 108 receives input information input by a keyboard, a mouse, a touch panel, or the like.

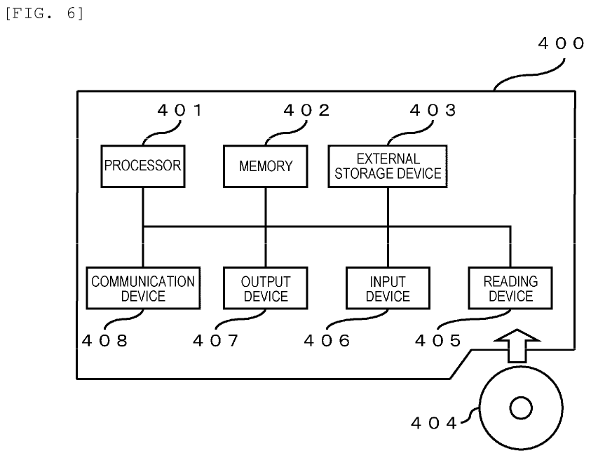

FIG. 6 shows an example of a hardware configuration of a delivery plan creating apparatus. The delivery plan creating apparatus 100 can be implemented by a general computer 400, or a network system including plural computers 400. The computer 400 includes a processor 401, a memory 402, an external storage device 403, a reading device 405 that reads information from a portable storage medium 404 such as a compact disk (CD) or a digital versatile disk (DVD), an input device 406 such as a keyboard, a mouse, or a barcode reader, an output device 407 such as a display, and a communication device 408 that communicates with another computer via a communication network such as the Internet. It is needless to say that the reading device 405 may write to as well as read the portable storage medium 404.

For example, the stowage rule generation unit 104, the attribute determination unit 105, and the delivery plan calculation unit 106 included in the processing unit 101 can be implemented by loading a predetermined program stored in the external storage device 403 into the memory 402 and executing the program by the processor 401, the display unit 107 and the input unit 108 can be implemented by the processor 401 using the input device 406 and the output device 407, and the storage unit 103 can be implemented by the processor 401 using the memory 402 or the external storage device 403.

The predetermined program may be downloaded into the external storage device 403 from the portable storage medium 404 via the reading device 405 or from the network via the communication device 408, and then loaded into the memory 402 and executed by the processor 401. Alternatively, the predetermined program may be directly loaded into the memory 402 from the portable storage medium 404 via the reading device 405 or from the network via the communication device 408, and then may be executed by the processor 401.

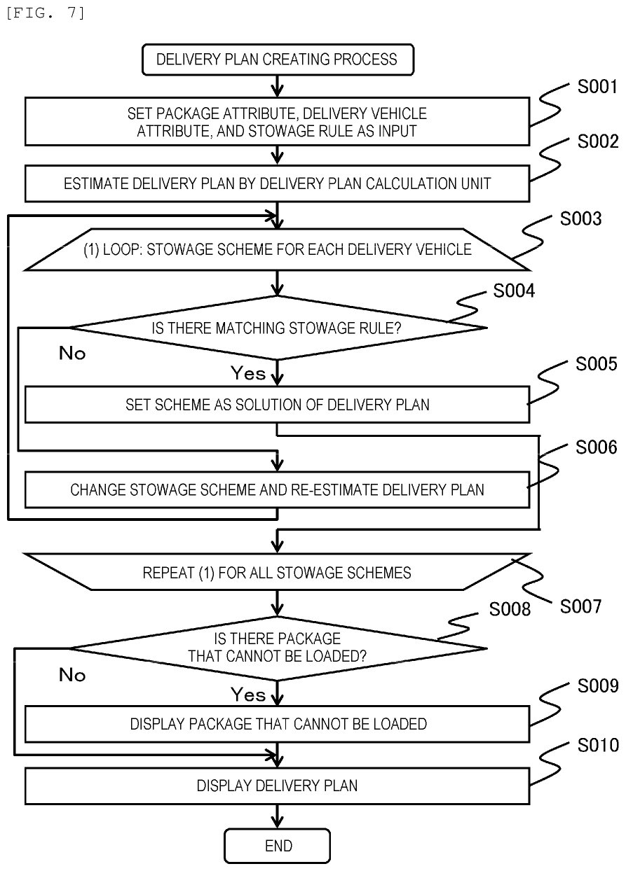

FIG. 7 shows an example of a flowchart of a delivery plan creating process. The delivery plan creating process is started when an input is received from the input unit 108 in the delivery plan creating apparatus 100 or when scheduled time is reached.

First, the delivery plan calculation unit 106 sets the package attribute, the delivery vehicle attribute, and the stowage rule as inputs (step S001). Specifically, the delivery plan calculation unit 106 reads the package attribute storage unit 201, the delivery vehicle attribute storage unit 202, and the stowage rule storage unit 203 into the memory 402.

Then, the delivery plan calculation unit 106 estimates a delivery plan (step S002). Specifically, the delivery plan calculation unit 106 calculates plural schemes (stowage schemes) for allocating a package to be delivered to a delivery vehicle using an algorithm of an existing product or the like.

The delivery plan calculation unit 106 implements steps S004 to S006 to be described below for each stowage scheme of each delivery vehicle (steps S003 and S007).

The delivery plan calculation unit 106 determines whether there is a matching stowage rule for the stowage scheme (step S004). Specifically, the delivery plan calculation unit 106 determines whether a rule of a stowage scheme of a target delivery vehicle matches any one of rules stored in the stowage rule storage unit 203. The stowage scheme of the target delivery vehicle focuses on a type of a package and a position in the cargo compartment where the package is to be loaded.

When there is a matching stowage rule (“Yes” in step S004), the delivery plan calculation unit 106 sets the scheme as a solution of the delivery plan (step S005).

When there is no matching stowage rule (“No” in step S004), the delivery plan calculation unit 106 changes the stowage scheme and re-estimates the delivery plan (step S006). Then, the delivery plan calculation unit 106 returns control to step S003.

The delivery plan calculation unit 106 determines whether there is a package that cannot be loaded (step S008). Specifically, the delivery plan calculation unit 106 determines whether there is a package that is not loaded on any of the delivery vehicles in a state where stowage schemes of all the delivery vehicles are adopted. When there is a package that cannot be loaded (“Yes” in step S008), the delivery plan calculation unit 106 displays the package that cannot be loaded on the display unit 107 (step S009).

When there is no package that cannot be loaded (“No” in step S008), the delivery plan calculation unit 106 displays the delivery plan (step S010).

The above is the example of a flow of the delivery plan creating process. By the delivery plan creating process, it is possible to create a delivery plan for allocating a package to a delivery vehicle so as to match a stowage rule based on performance. That is, by the delivery plan creating process, it is possible to create a delivery plan in consideration of loadability for a package when the package has a new shape or a shape of the package changes during a delivery process.

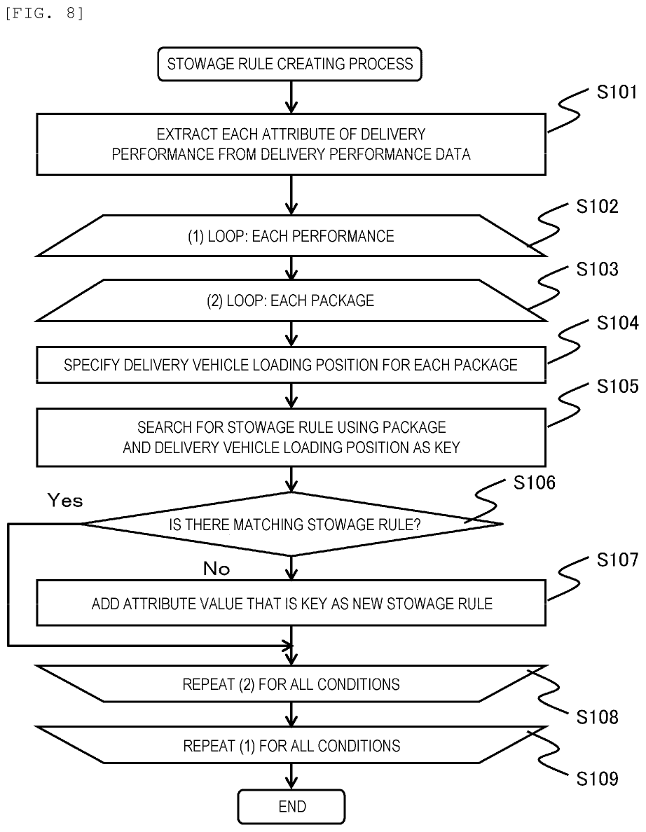

FIG. 8 shows an example of a flowchart of a stowage rule creating process. The stowage rule creating process is started when an input is received from the input unit 108 in the delivery plan creating apparatus 100 or when scheduled time is reached.

First, the stowage rule generation unit 104 extracts each attribute of the delivery performance from the delivery performance data 102 (step S101). Then, the stowage rule generation unit 104 implements steps S103 to S108 to be described below for the extracted delivery performance (steps S102 and S109).

The stowage rule generation unit 104 implements steps S104 to S107 to be described below for each package included in the delivery performance (steps S103 and S108).

The stowage rule generation unit 104 specifies a delivery vehicle loading position for each package (step S104). The stowage rule generation unit 104 searches the stowage rule storage unit 203 for a stowage rule using a package and the delivery vehicle loading position as a key (step S105).

The stowage rule generation unit 104 determines whether there is a matching stowage rule as a search result (step S106). When there is no matching stowage rule (“No” in step S106), the stowage rule generation unit 104 adds, as a new stowage rule, an attribute value that is a key to the stowage rule storage unit 203 (step S107).

When there is a matching stowage rule (“Yes” in step S106), the stowage rule generation unit 104 advances the control to step S108.

The above is the example of the flowchart of the stowage rule creating process. By the stowage rule creating process, it is possible to extract a stowage rule used in the delivery plan creating process from the delivery performance. Accordingly, it is possible to treat a package as being loadable if there is performance without specifically specifying a package having a new shape or a shape that changes due to processing.

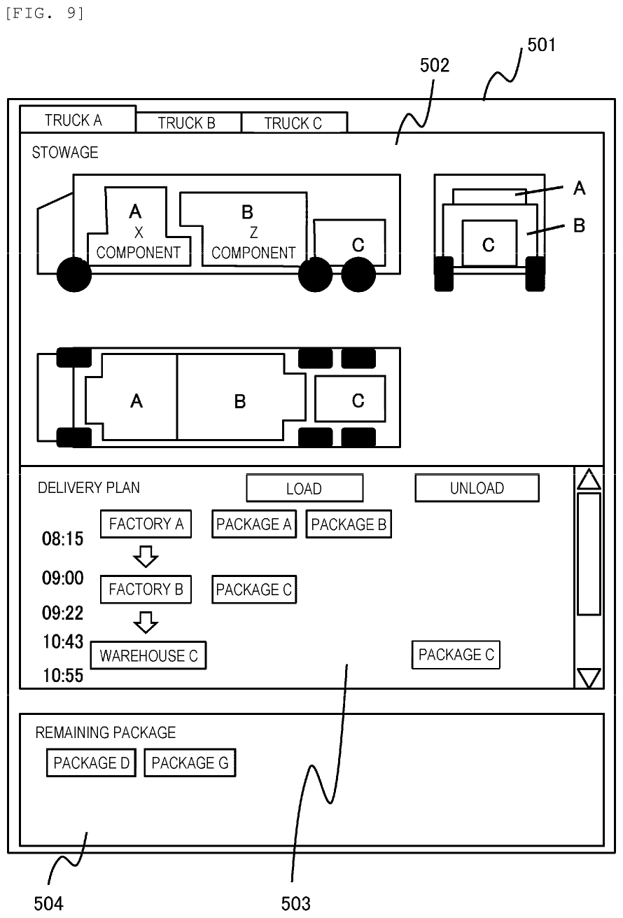

FIG. 9 shows an output example of the delivery plan. A display screen 501 includes a stowage display area 502, a delivery plan display area 503, and a remaining package display area 504. The stowage display area 502, the delivery plan display area 503, and the remaining package display area 504 maybe displayed in one window, or may be displayed indifferent windows having respective screens.

A stowage result for each delivery vehicle is displayed in the stowage display area 502. In the stowage display area 502, for example, when a delivery vehicle tab at the upper left of a screen is clicked, a stowage state of the target delivery vehicle is displayed. In the stowage display area 502, a shape of a stowed package is displayed from the top, side, and rear of the delivery vehicle. A package shape and a cargo compartment shape are created based on the image information 201d and 202e of the package attribute storage unit 201 and the delivery vehicle attribute storage unit 202, respectively.

In the delivery plan display area 503, a delivery plan for the delivery vehicle shown in the stowage display area 502 is displayed. In the delivery plan display area 503, a delivery order for a relevant delivery vehicle, departure and arrival time of respective bases, and a list of packages to be loaded or unloaded at the respective bases are displayed in a time chart format. In the remaining package display area 504, a package that cannot be stowed in the entire delivery plan is displayed.

The above is the delivery plan creating system according to the first embodiment. With the delivery plan creating system 1, it is possible to create a delivery plan in consideration of loadability for a package when the package has a new shape or a shape of the package changes during a delivery process without complicated work such as measuring the package. More specifically, it is easy to manage package shape data for loading by defining the package attributes for plural packages having complicated shapes and defining the delivery vehicle attributes for the loading restrictions of the delivery vehicle, and it is possible to shorten the overall calculation time by reducing stowage calculation at the time of creating a delivery plan.

In the above technique, the stowage rule of the stowage rule storage unit 203 is created based on the delivery performance data 102, the package attribute storage unit 201, and the delivery vehicle attribute storage unit 202. However, even if there is no actual stowage performance and the stowage rule is not stored, actually, a loadable stowage method may be separately present. One of methods for determining whether stowage is possible is to actually load a package on a delivery vehicle by trial and error, but it is difficult to perform trial and error of stowage by using an actual package when the actual package is large in size and heavy.

Therefore, as a second embodiment of the invention, the delivery plan creating system 1 may include a technique of complementing creation of a stowage rule. Specifically, the delivery plan creating apparatus 100 implements a technique in which the user uses the display screen 501 and creates a stowage rule by manual input based on visualization information of a package and a cargo compartment.

[Second Embodiment] A second embodiment will be described below. A delivery plan creating system according to the second embodiment is basically the same as the delivery plan creating system according to the first embodiment with differences. Hereinafter, the differences will be mainly described.

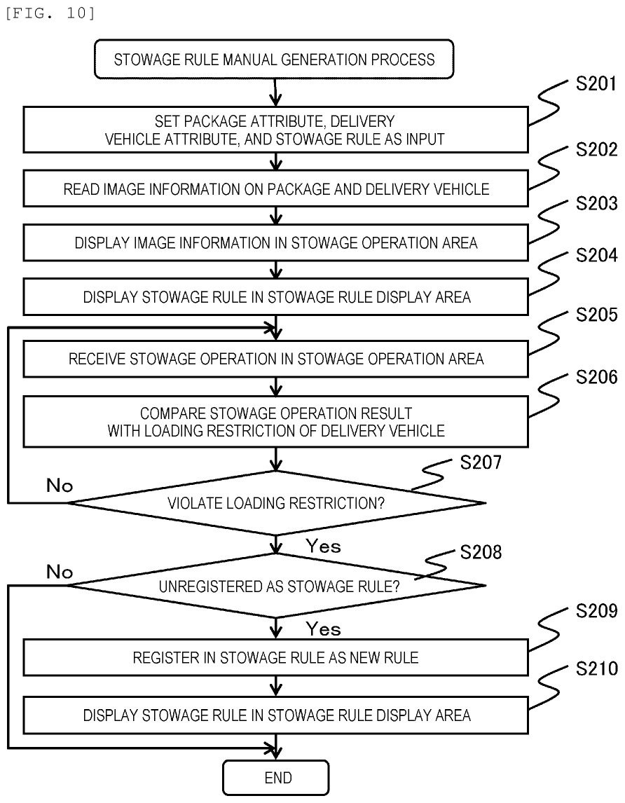

FIG. 10 shows an example of a flowchart of a stowage rule manual generation process. The stowage rule manual generation process is started when an input is received from the input unit 108 in the delivery plan creating apparatus 100.

First, the stowage rule generation unit 104 sets a package attribute, a delivery vehicle attribute, and a stowage rule as inputs (step S201). Specifically, the stowage rule generation unit 104 reads the package attribute storage unit 201, the delivery vehicle attribute storage unit 202, and the stowage rule storage unit 203 into the memory 402.

Then, the stowage rule generation unit 104 reads image information on a package and a delivery vehicle (step S202). Specifically, the stowage rule generation unit 104 reads the image information 201d of the package attribute storage unit 201 and image information 202e of the delivery vehicle attribute storage unit 202.

The stowage rule generation unit 104 displays the read image information on the package and the delivery vehicle in a stowage operation area of a display screen (step S203).

The stowage rule generation unit 104 reads a stowage rule from the stowage rule storage unit 203, and displays the stowage rule in a stowage rule display area of the display screen (step S204).

The stowage rule generation unit 104 receives a stowage operation in the stowage operation area of the display screen (step S205). Specifically, the stowage rule generation unit 104 receives an operation in which an image indicating the package is dragged by a mouse or the like to a predetermined position in a cargo compartment of the delivery vehicle in the stowage operation area, as the stowage operation in which the package is placed at the position.

The stowage rule generation unit 104 compares an operation result of the stowage operation area of the display screen with a loading restriction of the delivery vehicle (step S206). Specifically, the stowage rule generation unit 104 compares a loading scheme obtained from the operation result of the stowage operation area of the display screen with positions and attribute values of the loading restriction_1 (202h) and the loading restriction_2 (202i) of the delivery vehicle attribute storage unit 202.

The stowage rule generation unit 104 determines whether a stowage operation result of the stowage operation area violates the loading restriction (step S207). Specifically, the stowage rule generation unit 104 determines that the stowage operation result does not violate the loading restriction if the stowage operation result of the stowage operation area is a package loadable at each of loading positions of the loading restriction_1 (202h) and the loading restriction_2 (202i) of the delivery vehicle attribute storage unit 202 in a target delivery vehicle. In a case of violation (“No” in step S207), the stowage rule generation unit 104 returns control to step S205.

When the stowage operation result does not violate the loading restriction (“Yes” in step S207), the stowage rule generation unit 104 determines whether the stowage operation result is unregistered as a stowage rule (step S208). Specifically, when the stowage operation result of the stowage operation area is not stored in the stowage rule storage unit 203 as a stowage rule for the target delivery vehicle, the stowage rule generation unit 104 determines that the stowage operation result is unregistered. When the stowage operation result is registered (“No” in step S208), the stowage rule generation unit 104 ends the stowage rule manual generation process.

When the stowage operation result is unregistered (“Yes” in step S208), the stowage rule generation unit 104 registers the stowage operation result as a new rule in the stowage rule (step S209). Specifically, the stowage rule generation unit 104 stores the stowage operation result as a stowage rule in the stowage rule storage unit 203. The stored stowage rule is displayed in the stowage rule display area (step S210).

The above is an example of the flowchart of the stowage rule manual generation process. By the stowage rule manual generation process, a stowage scheme can be manually created or edited, and can be newly registered as a stowage rule if the stowage scheme is an unregistered stowage scheme.

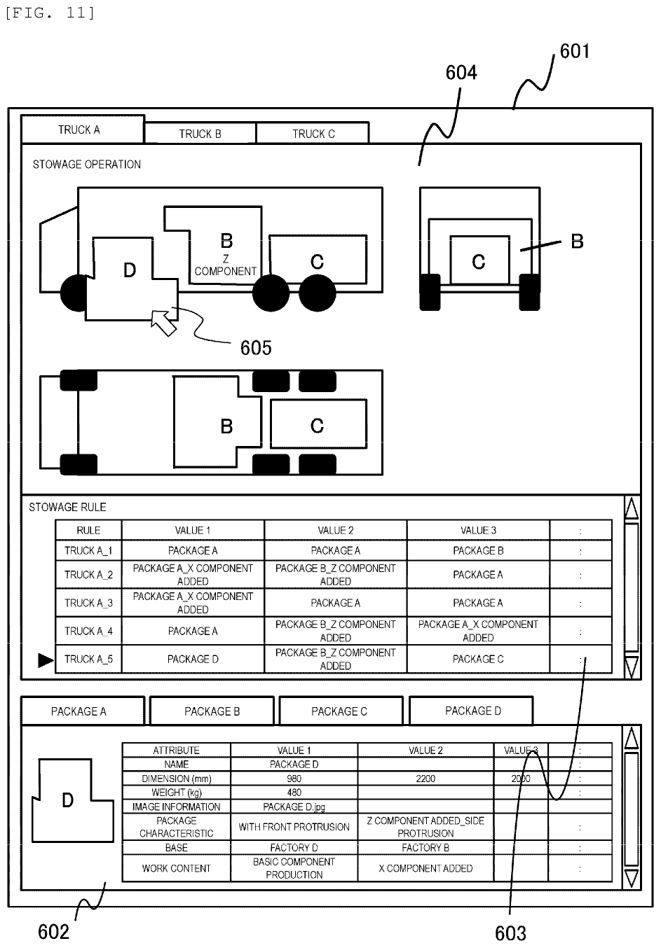

FIG. 11 shows an example of a display screen of a stowage operation. A display screen 601 includes a stowage operation area 604, a stowage rule display area 603, and a package display area 602. The stowage operation area 604, the stowage rule display area 603, and the package display area 602 may be displayed in one window, or may be displayed in different windows having respective screens.

In the stowage operation area 604, an editing screen for designing a stowage layout of a package 605 for each delivery vehicle by a drag operation is displayed. In the stowage operation area 604, for example, when a delivery vehicle tab at the upper left of a screen is clicked, a stowage state of the target delivery vehicle is displayed. In the stowage operation area 604, a shape of a package to be stowed is displayed from the top, side, and rear of the delivery vehicle. A package shape and a cargo compartment shape are created based on the image information 201d and 202e of the package attribute storage unit 201 and the delivery vehicle attribute storage unit 202, respectively.

In the stowage rule display area 603, a stowage rule stored in the stowage rule storage unit 203 is displayed. In the package display area 602, a tab for receiving selection of a package to be placed in the stowage operation area 604 is displayed, and a package attribute of the selected package is displayed.

The above is the delivery plan creating system according to the second embodiment. With the delivery plan creating system according to the second embodiment, it is possible to simulate a variation of stowage having no performance, and when there is a possibility of loading, it is possible to register the variation as a new stowage rule and use the rule for creating a delivery plan. More specifically, it is possible to implement a technique by which the user manually creates a stowage rule based on the visualization information of the package and the cargo compartment. Therefore, it is possible to handle stowage of a new package and a custom-made article.

In the above technique, the stowage rule of the stowage rule storage unit 203 is manually created one by one. Alternatively, when it can be estimated that a new package is similar to an existing package, that is, when attributes between packages are similar, the new package can be similarly handled even if stowage rules are different.

[Third Embodiment] Therefore, as a third embodiment of the invention, the delivery plan creating system 1 may include a technique of determining that a package can be delivered even a stowage scheme does not completely match a stowage rule as long as the stowage scheme satisfies a similar definition. Specifically, even if the stowage scheme does not match the stowage rule, the delivery plan creating apparatus 100 implements a technique of handling the stowage scheme as a solution of a delivery plan when the stowage scheme is similar to the stowage rule.

Hereinafter, the third embodiment will be described. A delivery plan creating system according to the third embodiment is basically the same as the delivery plan creating system according to the first embodiment with differences. Hereinafter, the differences will be mainly described.

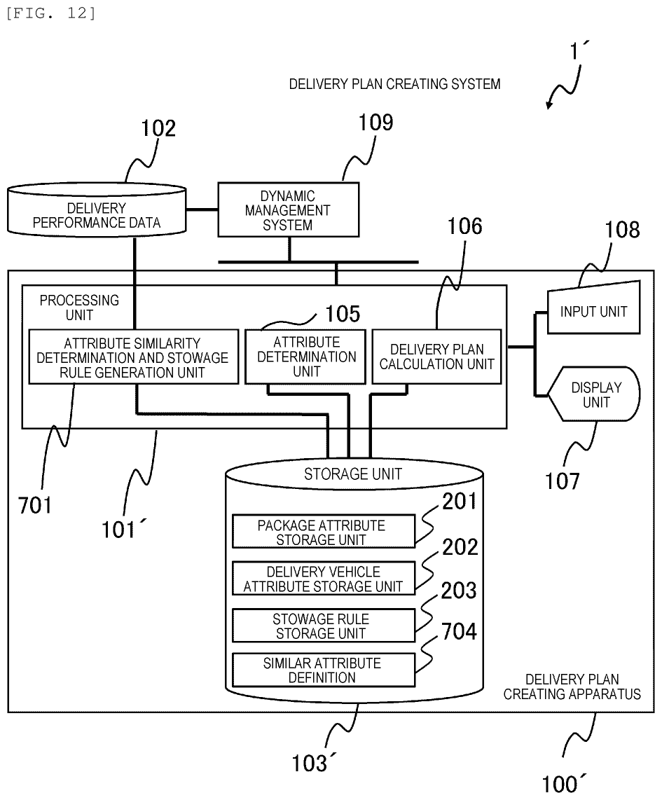

FIG. 12 shows a configuration example of another delivery plan creating system. In a delivery plan creating system 1′, a delivery plan creating apparatus 100′ is different from that of the first embodiment in that a processing unit 101′ includes an attribute similarity determination and stowage rule generation unit 701 and a storage unit 103′ includes a similar attribute definition 704.

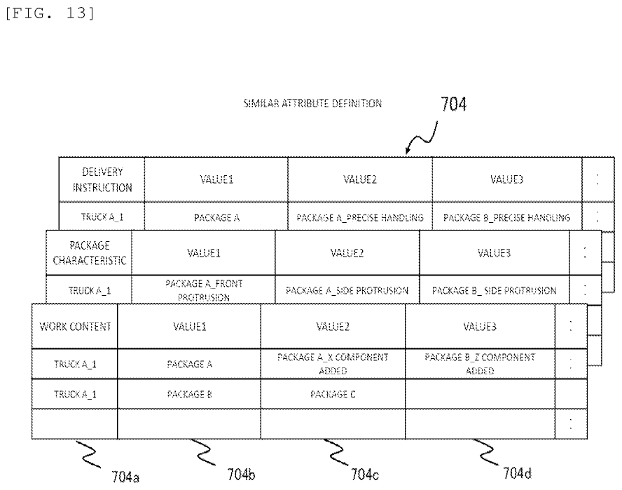

FIG. 13 shows an example of a data structure of a similar attribute definition. The similar attribute definition 704 has a configuration in a table format for each of the work content 201g, the package characteristic 201e, and the delivery instruction 201i in the package attribute storage unit 201. These configurations have the same format. In FIG. 13, the work content 201g will be described as an example. In the similar attribute definition 704, a similar attribute value is defined for each loading position of a delivery vehicle. For example, the work content 704a described in the similar attribute definition 704 includes “truck A_1”, and values of “package A” 704b, “package A_X component added” 704c, and “B component_Z component added” 704d are set as attribute values of the “truck A_1”. This indicates that, components indicated by three attribute values of the “package A” 704b, the “package A_X component added” 704c, and the “B component_Z component added” 704d are similar to each other, that is, the loading is compatible, when the components are loaded at a loading position No. 1 of the truck A.

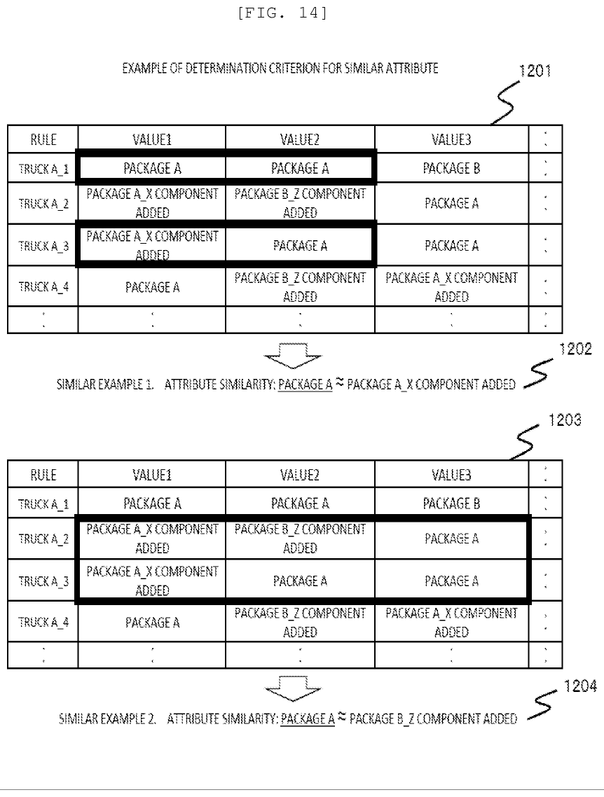

FIG. 14 shows an example of a determination criterion for a similar attribute. Generally, package stowage is affected not only by the shape of a package, but also by a structure of a cargo compartment of a delivery vehicle and the shape interference between packages during loading. Since the stowage rule storage unit 203 created based on the delivery performance data 102 is a deliverable stowage method actually, the stowage rule storage unit 203 satisfies all restrictions of the shape of the package, the structure of the cargo compartment of the delivery vehicle, and the shape interference between the packages during loading. Further, if attributes included in a stowage rule are compared with package attributes related to the shape of the package, the structure of the cargo compartment of the delivery vehicle, and the shape interference between the packages during loading, the attributes may be similar attributes that can be regarded as the same values although not the same.

In a determination example 1201 of a stowage rule, an example of similarity of attributes is shown. The determination example 1201 of the stowage rule describes attributes of a package that can be loaded at each loading position (values 1 to 3) of the delivery vehicle. A package at a certain loading position can be determined to be loadable in consideration of a structure of the cargo compartment of the delivery vehicle and interference of packages loaded at front and rear loading positions of the package. From this, paradoxically, packages having the same package attributes in front and rear of respective loading positions can be regarded as having the same attribute values.

In the determination example 1201 of the stowage rule, packages (rules surrounded by thick lines, respectively) of “package A” and “package A_X component added” at a loading position No. 1, at which a loading position No. 0 (front) is “none” and a loading position No. 2 (rear) is “package A”, can be interpreted as similar, that is, it can be said that package A≈package A_X component added when the package A and the package A_X component added are placed at the loading position No. 1 and packages in front and rear of the package A and the package A_X component added are the same (similar example 1202).

Further, in a determination example 1203 of the stowage rule, packages of “package B_Z component added” and “package A” at a loading position No. 2, at which a loading position No. 1 (front) is “package A_X component added” and a loading position No. 3 (rear) is “package A”, can be interpreted as similar. That is, it can be said that package A≈package B_Z component added when the package A and the package B_Z component added are placed at the loading position No. 2 and packages in front and rear of the package A and the package B_Z component added are the same (similar example 1204).

Similar examples 1202 and 1204 both include the package “package A” common to elements thereof, but “package A_X component added” and “package B_Z component added” are not interpreted to be similar. Since the loading position and the structure of the cargo compartment of the delivery vehicle are considered as restrictions, the attributes are not considered similar when the loading positions are different.

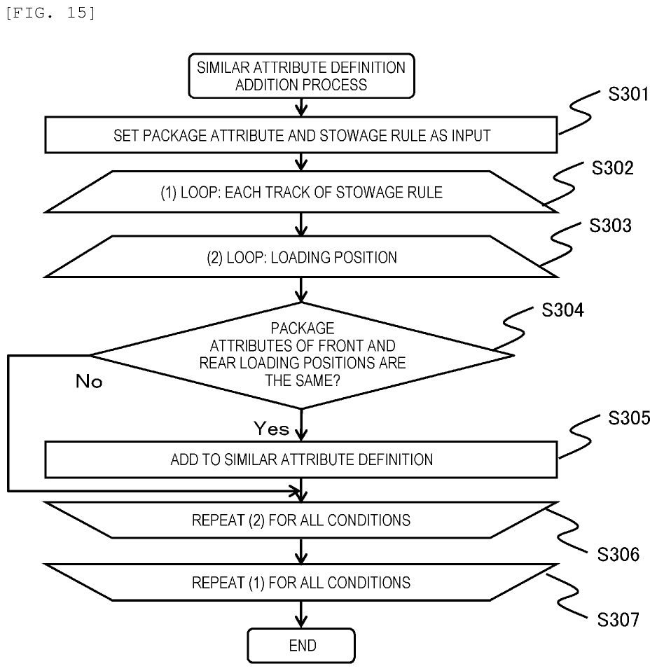

FIG. 15 shows an example of a flowchart of a similar attribute definition addition process. The similar attribute definition addition process is started when an input is received from the input unit 108 in the delivery plan creating apparatus 100 or when scheduled time is reached. As described above, the similar attribute definition 704 has a configuration in a table format for each of a work content, a package characteristic, and a delivery instruction, and the work content will be described here as an example since any generation process can be generated by using the same algorithm.

First, the stowage rule generation unit 104 sets the package attribute storage unit 201 and the stowage rule storage unit 203 as inputs (step S301). Specifically, the stowage rule generation unit 104 reads the package attribute storage unit 201 and the stowage rule storage unit 203 into the memory 402.

The stowage rule generation unit 104 implements steps S303 to S306 to be described below for each delivery vehicle (strictly, a type of a cargo compartment layout) of the stowage rule storage unit 203 (steps S302 and S307).

The stowage rule generation unit 104 implements steps S304 to S305 to be described below for each loading position in the delivery vehicle (steps S303 and S306).

The stowage rule generation unit 104 determines whether there is another stowage rule in which package attributes in front and rear of corresponding loading positions are the same (step S304). When there is a stowage rule in which the package attributes in front and rear of the loading positions are the same (“Yes” in step S304), the stowage rule generation unit 104 adds a similarity relation to the similar attribute definition 704 (step S305). When there is no stowage rule in which the package attributes in front and rear of the loading positions are the same (“No” in step S304), the stowage rule generation unit 104 advances the control to step S306.

The above is an example of the flowchart of the similar attribute definition addition process. By the similar attribute definition addition process, it is possible to automatically generate a similar definition for determining that delivery is possible if a stowage scheme does not completely match a stowage rule but is similar to the stowage rule.

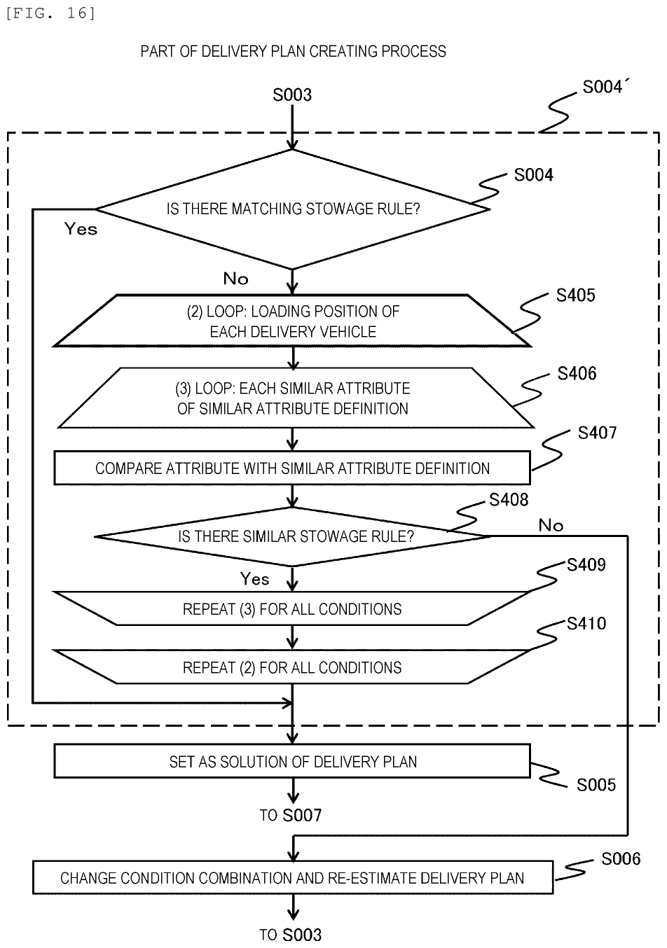

FIG. 16 shows a part of an example of a flowchart of a delivery plan creating process. A delivery plan creating process in the third embodiment is basically the same as the delivery plan creating process in the first embodiment, but is different in a process in step S004 (step S004′), and adopts a stowage scheme as a solution of a delivery plan even if the stowage scheme matches a similar stowage rule. Details will be described below.

The delivery plan calculation unit 106 determines whether there is a matching stowage rule for a target stowage scheme of each delivery vehicle (step S004). Specifically, the delivery plan calculation unit 106 determines whether a rule of the stowage scheme of a target delivery vehicle matches any one of rules stored in the stowage rule storage unit 203 focusing on a type of a package and a position in the cargo compartment where the package is to be loaded.

When there is a matching stowage rule (“Yes” in step S004), the delivery plan calculation unit 106 sets the scheme as a solution of the delivery plan (step S005).

When there is no matching stowage rule (“No” in step S004), the delivery plan calculation unit 106 repeatedly implements steps S406 to S409 for each loading position of the delivery vehicle (steps S405 and S410).

The delivery plan calculation unit 106 repeatedly implements steps S407 to S408 for each similar attribute of the similar attribute definition 704 (steps S406 and S409).

The delivery plan calculation unit 106 compares an attribute of the scheme with the similar attribute of the similar attribute definition 704 (step S407). The delivery plan calculation unit 106 determines whether there is a similar stowage rule (step S408). When there is a similar stowage rule (“Yes” in step S408), the delivery plan calculation unit 106 advances control to step S409.

When there is no similar stowage rule (“No” in step S408), the delivery plan calculation unit 106 changes the stowage scheme and re-estimates the delivery plan (step S006). The delivery plan calculation unit 106 returns the control to step S003.

The above is an example of the flowchart of the delivery plan creating process according to the third embodiment. By the delivery plan creating process of the third embodiment, it is possible to create a delivery plan by determining that delivery is possible if a stowage scheme does not completely match a stowage rule but is similar to the stowage rule.

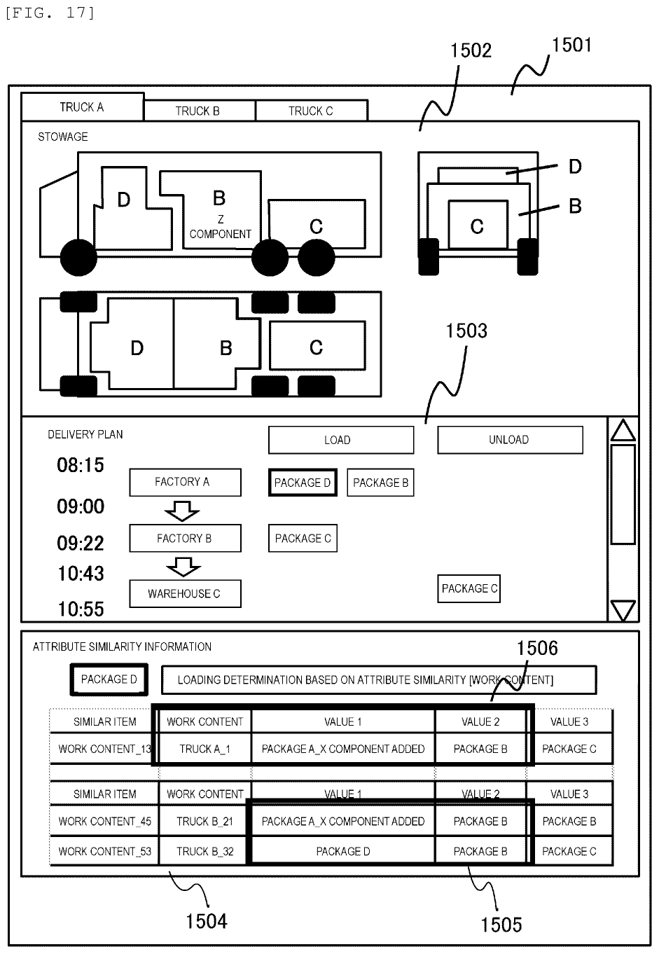

FIG. 17 shows an output example of a delivery plan. A display screen 1501 includes a stowage display area 1502, a delivery plan display area 1503, and an attribute similarity information display area 1504. The stowage display area 1502, the delivery plan display area 1503, and the attribute similarity information display area 1504 may be displayed in one window, or may be displayed in different windows having respective screens.

A stowage result for each delivery vehicle is displayed in the stowage display area 1502. In the stowage display area 1502, for example, when a delivery vehicle tab at the upper left of a screen is clicked, a stowage state of the target delivery vehicle is displayed. In the stowage display area 1502, a shape of a stowed package is displayed from the top, side, and rear of the delivery vehicle. A package shape and a cargo compartment shape are created based on the image information 201d and 202e of the package attribute storage unit 201 and the delivery vehicle attribute storage unit 202, respectively.

In the delivery plan display area 1503, a delivery plan for the delivery vehicle shown in the stowage display area 1502 is displayed. In the delivery plan display area 1503, a delivery order for a relevant delivery vehicle, departure and arrival time of respective bases, and a list of packages to be loaded or unloaded at the respective bases are displayed in a time chart format. When a certain package is loaded by attribute similarity determination, a target package is highlighted, for example, in bold or highlight. This makes it easier for the user to recognize the package.

In the attribute similarity information display area 1504, packages determined to be stowable due to similarity in the delivery plan are displayed. For example, a similarity display 1505 shows that, from similar items of a work content_45 and a work content_53, the package B can be placed at a subsequent loading position 2 regardless whether “package A_X component added” or “package D” is loaded at a loading position 1, and thus “package A_X component added” and “package D” at the loading position 1 are similar to each other as long as “package B” is placed at the loading position 2.

A similarity display 1506 displays similar attribute information that is a basis for determining that the “package D” can be loaded at the loading position 1 of “truck A_1”. Specifically, since “package A_X component added” is loaded at the loading position 1 of “truck A_1” and “package B” is loaded at the loading position 2, “package D” has an attribute similar to “package A_X component added”.

The above is the delivery plan creating system according to the third embodiment. With the delivery plan creating system according to the third embodiment, it is possible to analogize and simulate a variation of stowage having no performance, and when there is a possibility of loading, it is possible to register the variation as a new stowage rule and use the rule for creating a delivery plan. More specifically, regarding performance of arranging different packages at the same loading position, when packages loaded in front and rear of the different packages match, it is considered that the different packages can be loaded, and thus the technique of automatically adding the performance as a stowage rule can be implemented. Therefore, it is possible to handle stowage of a new package and a custom-made article.

The invention is not limited to the above embodiments, and includes various modifications. For example, the above embodiments have been described in detail for easy understanding of the invention, and the invention is not necessarily limited to those including all of the configurations described above. Apart of a configuration of one embodiment can be replaced with a configuration of another embodiment, and the configuration of another embodiment can be added to the configuration of one embodiment. A part of a configuration of the embodiments may be subjected to addition, deletion and replacement of another configuration.

A part or all of the configurations, functions, processing units, processing methods or the like described above may be implemented by hardware such as through design using an integrated circuit. The above configurations, functions, or the like may be implemented by software by means of a processor interpreting and executing a program for implementing respective functions. Information such as a program, a table, and a file for implementing the respective functions can be stored in a recording device such as a memory, a hard disk, or a SSD, or in a recording media such as an IC card, an SD card, or a DVD.

Control lines or information lines indicate what is considered necessary for description, and not all the control lines or information lines are necessarily shown in a product. In practice, it may be considered that almost all configurations are connected to each other.

### Reference Sign List

1 delivery plan creating system

100 delivery plan creating apparatus

101 processing unit

102 delivery performance data

103 storage unit

104 stowage rule generation unit

105 attribute determination unit

106 delivery plan calculation unit

107 display unit

108 input unit

109 dynamic management system

201 package attribute storage unit

202 delivery vehicle attribute storage unit

203 stowage rule storage unit

1. A delivery plan creating system comprising:
a stowage rule generation unit configured to generate stowage rules using delivery performance data including records of a type of a delivery vehicle and a type of a package to be delivered by the delivery vehicle, and store the stowage rules in a stowage rule storage unit;
a delivery plan calculation unit configured to estimate a scheme of the package to be loaded on the delivery vehicle, and create a delivery plan using the scheme when the package to be loaded on the delivery vehicle in the scheme matches one of the stowage rules; and
a display unit configured to display the delivery plan.

2. The delivery plan creating system according to claim 1, wherein
the delivery performance data includes information for specifying a loading position of the package in a cargo compartment of the delivery vehicle,
the stowage rule generation unit includes the delivery vehicle, the package, and the loading position in the stowage rules, and
the delivery plan calculation unit creates the delivery plan using the scheme when the package to be loaded on the delivery vehicle and the loading position of the package in the scheme match one of the stowage rules.

3. The delivery plan creating system according to claim 1, wherein
when a result of combining and editing, in the display unit, an image imitating a shape of the cargo compartment of the delivery vehicle and an image imitating a shape of the package is not stored in the stowage rule storage unit as the stowage rules, the stowage rule generation unit stores the result as a new stowage rule.

4. The delivery plan creating system according to claim 1, further comprising:
an attribute similarity determination and stowage rule generation unit configured to determine similarity between stowage rules and generate a similar attribute definition defining an attribute of a similar package.

5. The delivery plan creating system according to claim 1, further comprising:
an attribute similarity determination and stowage rule generation unit configured to determine similarity between stowage rules and generate a similar attribute definition defining an attribute of a similar package, wherein
the delivery plan calculation unit creates the delivery plan using the scheme when the package to be loaded on the delivery vehicle in the scheme matches one of the stowage rules or when the package does not match any one of the stowage rules but corresponds to the definition of the attribute of the similar package.

6. The delivery plan creating system according to claim 1, wherein
the display unit displays a package that is not loaded on any delivery vehicle in the delivery plan.

7. A delivery plan creating apparatus comprising:
a processor;
a storage device; and
a display device, wherein
the processor is configured to implement:
a stowage rule generation step of generating stowage rules using delivery performance data including records of a type of a delivery vehicle and a type of a package to be delivered by the delivery vehicle, and storing the stowage rules in a stowage rule storage unit of the storage device;
a delivery plan calculation step of estimating a scheme of the package to be loaded on the delivery vehicle, and creating a delivery plan using the scheme when the package to be loaded on the delivery vehicle in the scheme matches one of the stowage rules; and
a display step of displaying the delivery plan on the display device.

8. A delivery plan creating method using a delivery plan creating system, wherein
the delivery plan creating system is configured to implement:
a stowage rule generation step of generating stowage rules using delivery performance data including records of a type of a delivery vehicle and a type of a package to be delivered by the delivery vehicle, and storing the stowage rules in a stowage rule storage unit;
a delivery plan calculation step of estimating a scheme of the package to be loaded on the delivery vehicle, and creating a delivery plan using the scheme when the package to be loaded on the delivery vehicle in the scheme matches one of the stowage rules; and
a display step of displaying the delivery plan.
